(19) United States
(12) Patent Application Publication
(10) Pub. No.: US 2022/0208065 A1
(43) Pub. Date: Jun. 30, 2022

(54) IMAGE PROCESSING DEVICE, METHOD, IMAGE DISPLAY DEVICE, AND RECORDING MEDIUM

(71) Applicant: Mitsubishi Electric Corporation, Tokyo (JP)

(72) Inventor: Toshiaki KUBO, Tokyo (JP)

(73) Assignee: Mitsubishi Electric Corporation, Tokyo (JP)

(21) Appl. No.: 17/606,768

(22) PCT Filed: May 9, 2019
(86) PCT No.: PCT/JP2019/018561

§ 371 Date: Oct. 27, 2021

(51) Int. Cl. G09G 3/20

(52) U.S. Cl. CPC G09G 3/2003; G09G 2320/0233; G09G 2320/041; G09G 2340/16; G09G 2320/0242

(57) ABSTRACT

In an image processing device that causes an image display in which multiple light emitting elements each including multiple LEDs are arranged, to display an image, the temperatures of the light emitting elements are estimated based on a result of learning of a relationship between image data items of input images of multiple frames and measured values of the temperatures of the light emitting elements, and unevenness in at least one of luminance and chromaticity of the light emitting elements is corrected based on the estimated temperatures. It is possible to compensate unevenness in at least one of luminance and chromaticity of the light emitting elements due to temperature variation without a temperature sensor being provided for each light emitting element.

### TECHNICAL FIELD

The present invention relates to an image processing device, a method, and an image display device. The present invention also relates to a program and a recording medium. In particular, the present invention relates to a technique of correcting unevenness in luminance or chromaticity of a display panel.

### BACKGROUND ART

There is known a display panel in which light emitting elements each consisting of a set of red, green, and blue LEDs are arranged as pixels in a matrix.

In general, light emitting elements formed by LEDs have variation in the luminance or chromaticity of the generated light. Also, the luminance or chromaticity of the generated light varies with temperature. Thus, unevenness in luminance or chromaticity occurs in the displayed image.

Patent Literature 1 proposes a method of measuring a temperature of LEDs of a backlight of a liquid crystal display panel by means of a temperature sensor and correcting image data by using correction data for each temperature.

### CITATION LIST

### Patent Literature

Patent Literature 1: International Publication No. 2011-125374 (paragraphs 0045 and 0050-0053, and FIG. 1)

### SUMMARY OF INVENTION

### Technical Problem

In a display panel in which multiple light emitting elements are arranged in a matrix, since currents passed through the individual light emitting elements vary depending on the displayed content, the individual light emitting elements have different temperatures.

The temperature variation may cause luminance unevenness or color unevenness. This is because light emitting elements formed by LEDs vary in color or luminance with temperature.

As described above, in the technique of Patent Literature 1, the temperature sensor is provided for the backlight of the liquid crystal display panel. However, when this concept is applied to a display panel including multiple light emitting elements, it is necessary to provide a temperature sensor for each light emitting element, thus increasing the number of temperature sensors, wiring therefor, and the space for the installation.

The present invention is intended to provide an image processing device capable of compensating unevenness in at least one of luminance and chromaticity of light emitting elements due to temperature variation without a temperature sensor being provided for each light emitting element.

### Solution to Problem

An image processing device of the present invention is an image processing device to correct unevenness in at least one of luminance and color of an image display in which a plurality of light emitting elements each including a plurality of LEDs are arranged, the image processing device including: an element temperature estimator to estimate temperatures of the respective light emitting elements from image data items of input images of a plurality of last frames including a current frame and an ambient temperature of the image display; and a temperature variation compensator to correct the image data item of the input image of the current frame on a basis of the temperatures of the respective light emitting elements, thereby correcting unevenness in at least one of luminance and chromaticity of the light emitting elements, wherein the element temperature estimator estimates the temperatures of the light emitting elements on a basis of a result of learning of a relationship between the image data items of the input images of the plurality of frames and measured values of the temperatures of the light emitting elements.

### Advantageous Effects of Invention

The image processing device of the present invention can estimate the temperature of each light emitting element from the input images and ambient temperature, and compensate unevenness in at least one of luminance and chromaticity of the light emitting elements due to temperature variation without a temperature sensor being provided for each light emitting element.

### BRIEF DESCRIPTION OF DRAWINGS

FIG. 1 is a diagram illustrating an image display device including an image processing device of a first embodiment of the present invention.

FIGS. 2A and 2B are diagrams illustrating an example of variations in luminance and chromaticity with temperature of a light emitting element.

FIG. 3 is a diagram illustrating a computer that implements the function of the image processing device, together with an image display and an ambient temperature measurement unit.

FIG. 4 is a diagram illustrating a configuration of a memory region of an input image storage of FIG. 1.

FIG. 5 is a block diagram illustrating a configuration example of an element temperature estimator of FIG. 1.

FIG. 6 is a diagram illustrating an example of a relationship between an input and an output defined by a conversion table stored in a conversion table storage in FIG. 5.

FIGS. 7A and 7B are diagrams illustrating an example of relationships between inputs and outputs defined by compensation tables stored in a compensation table storage of FIG. 1.

FIG. 8 is a flowchart illustrating the procedure of a process when the function of the image processing device of the first embodiment is implemented by a computer.

FIG. 9 is a flowchart illustrating a specific example of a step of element temperature estimation of FIG. 8.

FIG. 10 is a block diagram illustrating the image display device of FIG. 1, a learning device, an element temperature measurement unit, and a temperature control device.

FIG. 11 is a flowchart illustrating the procedure of a process in learning according to a first method performed by using the learning device of FIG. 10.

FIG. 12 is a flowchart illustrating the procedure of a process in learning according to a second method performed by using the learning device of FIG. 10.

FIG. 13 is a flowchart illustrating the procedure of the process in learning according to the second method performed by using the learning device of FIG. 10.

FIG. 14 is a diagram illustrating an image display device including an image processing device of a second embodiment of the present invention.

FIG. 15 is a flowchart illustrating the procedure of a process when the function of the image processing device of the second embodiment is implemented by a computer.

FIG. 16 is a diagram illustrating an image display device including an image processing device of a third embodiment of the present invention.

FIG. 17 is a diagram illustrating an example of a neural network that forms an element temperature estimator of FIG. 16.

FIG. 18 is a flowchart illustrating the procedure of a process when the function of the image processing device of the third embodiment is implemented by a computer.

FIG. 19 is a block diagram illustrating the image display device of FIG. 16, a learning device, an element temperature measurement unit, and a temperature control device.

FIG. 20 is a flowchart illustrating the procedure of a process in learning performed by using the learning device of FIG. 19.

FIG. 21 is a flowchart illustrating the procedure of the process in learning performed by using the learning device of FIG. 19.

### DESCRIPTION OF EMBODIMENTS

### First Embodiment

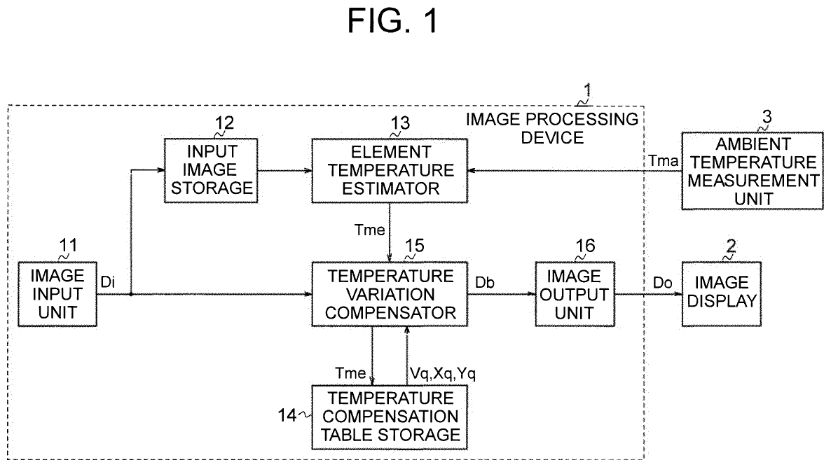

FIG. 1 is a diagram illustrating an image display device including an image processing device of a first embodiment of the present invention. The image display device of the first embodiment includes, besides the image processing device 1, an image display 2 and an ambient temperature measurement unit 3.

The image display 2 is formed by a display including a display panel in which red, green, and blue LEDs are arranged. For example, one light emitting element is formed by a set of red, green, and blue LEDs, and multiple such light emitting elements are regularly arranged as pixels in a matrix, so that the display panel is formed. For example, each light emitting element is one which is referred to as a 3-in-1 LED light emitting element and in which a red LED chip, a green LED chip, and a blue LED chip are provided in a single package.

Both or one of the luminance and chromaticity of light generated by a light emitting element constituted by LEDs vary with temperature.

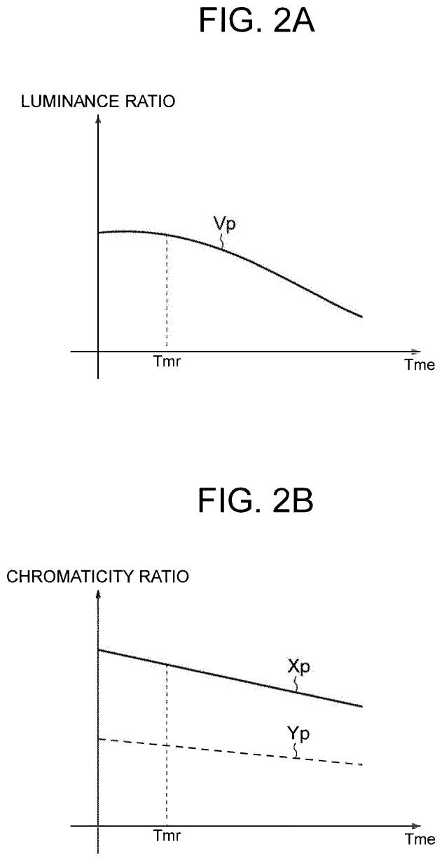

FIG. 2A illustrates an example of the variation in the luminance Vp with temperature.

FIG. 2B illustrates an example of the variation in the chromaticity with temperature. The chromaticity is represented by X and Y stimulus values of the CIE-XYZ color system, for example. FIG. 2B illustrates the variations in the X stimulus value Xp and Y stimulus value Yp.

The ambient temperature measurement unit 3 measures a temperature around the display panel and outputs the measured value Tma.

The ambient temperature measurement unit 3 includes one or more temperature sensors formed by thermistors or thermocouples, for example. The one or more temperature sensors are located so that they can measure one or both of the temperatures outside and inside a housing of the image display 2. When a temperature sensor is located outside the housing, it may be embedded in a front frame, for example.

The ambient temperature measurement unit 3 outputs the measured ambient temperature Tma.

When temperatures are measured by two or more temperature sensors, an average of them may be output as the ambient temperature Tma.

The image processing device 1 may be partially or wholly formed by processing circuitry.

For example, the functions of respective portions of the image processing device may be implemented by respective separate processing circuits, or the functions of the portions may be implemented by a single processing circuit.

The processing circuitry may be implemented by hardware, or by software or a programmed computer.

It is possible that a part of the functions of the respective portions of the image processing device is implemented by hardware and another part is implemented by software.

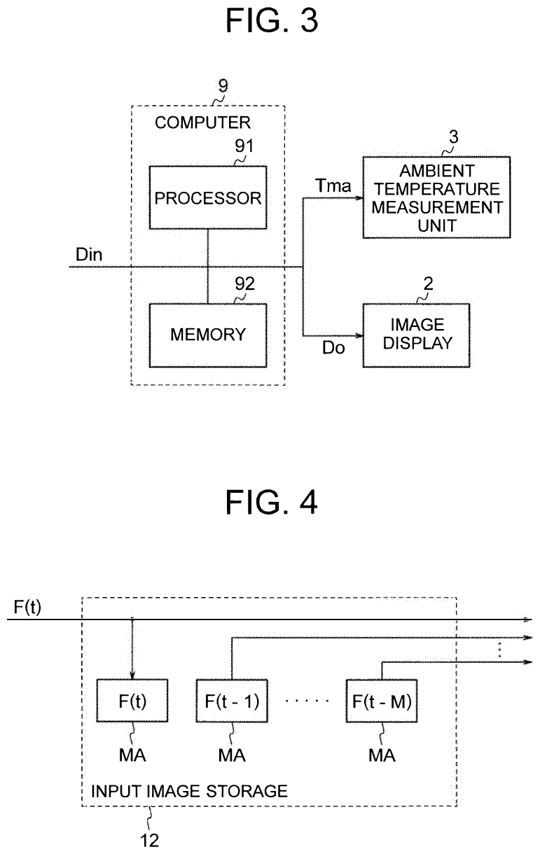

FIG. 3 illustrates a computer 9 that implements all the functions of the image processing device 1, together with the image display 2 and ambient temperature measurement unit 3.

In the illustrated example, the computer 9 includes a processor 91 and a memory 92.

A program for implementing the functions of the respective portions of the image processing device 1 is stored in the memory 92.

The processor 91 uses, for example, a central processing unit (CPU), a graphics processing unit (GPU), a microprocessor, a microcontroller, a digital signal processor (DSP), or the like.

The memory 92 uses, for example, a semiconductor memory, such as a random access memory (RAM), a read only memory (ROM), a flash memory, an erasable programmable read only memory (EPROM), or an electrically erasable programmable read only memory (EEPROM), a magnetic disk, an optical disk, a magnetic optical disk, or the like.

The processor 91 implements the function of the image processing device by executing the program stored in the memory 92.

The function of the image processing device includes control of display on the image display 2, as described above.

Although the computer of FIG. 3 includes a single processor, it may include two or more processors.

FIG. 1 illustrates functional blocks constituting the image processing device 1.

The image processing device 1 includes an image input unit 11, an input image storage 12, an element temperature estimator 13, a compensation table storage 14, a temperature variation compensator 15, and an image output unit 16.

In this embodiment, the image input unit 11 is described as being a digital interface that receives and outputs digital image data. However, the image input unit 11 may be formed by an A/D converter that converts an analog image signal to digital image data.

The image input unit 11 outputs digital image data to the input image storage 12 and temperature variation compensator 15, as input image data.

The input image storage 12 stores input image data items of multiple frames.

The input image storage 12 includes multiple storage regions MA, for example, as illustrated in FIG. 4, and can hold image data items of multiple frames. Specifically, it can hold an image data item F(t) of a newly input frame (which is an input image data item of a current frame) and one or more image data items F(t−1) to F(t−M) of one or more preceding frames (which are input image data items of previous frames).

In the above symbols denoting the image data items, t denotes the current time, and F(t−m) denotes an input image data item that is m frames (m being from 1 to M) prior to the input image data item of the current frame. M is an integer of 1 or more.

The input image data item F(t) of the current frame and the input image data items F(t−1) to F(t−M) of the previous frames constitute a time series SE of image data items.

Each image data item has, for each pixel, red, green, and blue pixel values. A time series of image data items for each pixel is a time series of pixel values.

The element temperature estimator 13 estimates temperatures of the respective light emitting elements on the basis of the ambient temperature Tma measured by the ambient temperature measurement unit 3 and the time series SE of image data items that is constituted by the image data items of the multiple frames and output from the input image storage 12, and outputs the estimated values Tme.

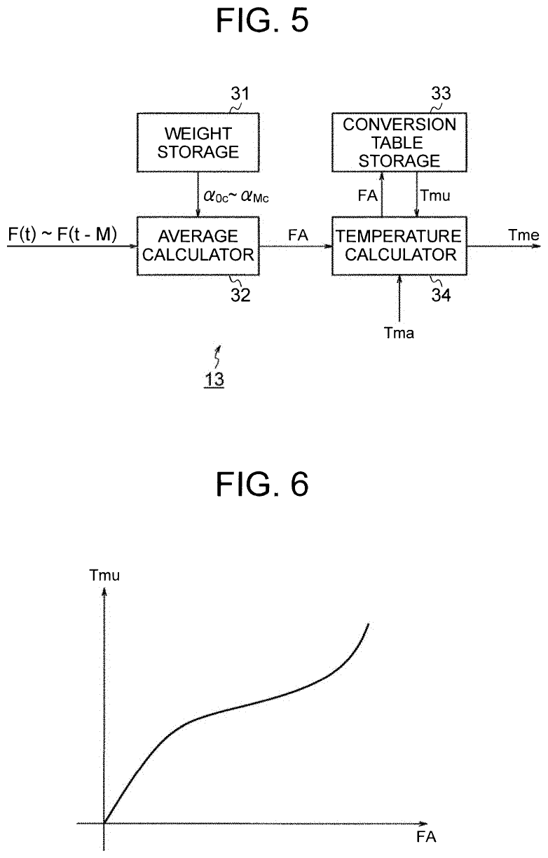

The element temperature estimator 13 includes a weight storage 31, an average calculator 32, a conversion table storage 33, and a temperature calculator 34, for example, as illustrated in FIG. 5.

The average calculator 32 receives the input image data items F(t), F(t−1), . . . , F(t−M) of the last M+1 frames constituting the above time series SE.

The weight storage 31 stores, for each color, weights α_{0c} to α_{Mc}. Here, c is R, G, or B. That is, the weight storage 31 stores weights α_{0R} to α_{MR} for red, weights α_{0G} to α_{MG} for green, and weights an to α_{MB} for blue, and thus stores (M+1)×3 weights.

A set of these weights α_{0R} to α_{MR}, α_{0G} to α_{MG}, and an to α_{MB} will be referred to as a weight set WS, and denoted by the symbol WS.

The average calculator 32 calculates a weighted average FA on the basis of the input image data items F(t) to F(t−M) of the last M+1 frames and the weight set WS. The calculation of the weighted average is performed for each pixel.

The calculation of the weighted average FA(x,y) for each pixel (a pixel of interest) is represented by the following Equation (1):

$$FA ( x , y ) = {α}_{0 R} \times F ( t , x , y , R ) + {α}_{1 R} \times F ( t - 1 , x , y , R ) + … + {α}_{MR} \times F ( t - M , x , y , R ) + {α}_{0 G} \times F ( t , x , y , G ) + {α}_{1 G} \times F ( t - 1 , x , y , G ) + … + {α}_{MG} \times F ( t - M , x , y , G ) + {α}_{0 B} \times F ( t , x , y , B ) + {α}_{1 B} \times F ( t - 1 , x , y , B ) + … + {α}_{MB} \times F ( t - M , x , y , B ) . \qquad Equation ( 1 )$$

In Equation (1), x denotes a horizontal position of the pixel of interest, and y denotes a vertical position of the pixel of interest.

As shown in Equation (1), the weights α_{0c} to α_{Mc} (c being R, G, or B) are multiplied by the image data items F(t) to F(t−M) in the product-sum operation for determining the weighted average.

For each color c (R, G, or B), the weights have the relationship of

α_{0c}≥α_{1c}≥ . . . ≥α_{Mc}.

Thus, the weight for the image data item of a later frame (the image data item of a frame closer to the current time) of the image data items of the multiple frames constituting the time series SE has a larger value.

The weights are determined by machine learning as described later, and are stored.

FIG. 6 illustrates an example of a relationship between an input and an output defined by a conversion table CA stored in the conversion table storage 33.

In FIG. 6, the horizontal axis represents the weighted average FA as the input of the conversion table CA, and the vertical axis represents a temperature rise Tmu as the output of the conversion table CA. The temperature rise Tmu mentioned here refers to the amount of increase in temperature.

The conversion table storage 33 stores the conversion table CA illustrated as an example in FIG. 6, and outputs the temperature rise Tmu corresponding to the input weighted average FA.

The conversion table CA is also generated by machine learning as described later, and is stored.

The conversion table CA is assumed to have a value of the temperature rise Tmu for each of the values that can be taken by the weighted average FA. However, this is not mandatory. Specifically, it is possible to discretely hold values of the temperature rise Tmu for weighted averages FA, and determine, by interpolation, the corresponding values of the temperature rise Tmu for weighted averages FA for which no values of the temperature rise Tmu are held. The interpolation can be performed by using the values of the temperature rise corresponding to the values (table points) of the weighted average FA having the values of the temperature rise, for example.

The temperature calculator 34 determines a temperature rise Tmu(x,y) for each pixel on the basis of the weighted average FA(x,y) for each pixel and the conversion table CA, and further calculates temperatures (which are estimated values) Tme(x,y) at the pixel positions on the basis of the ambient temperature Tma and temperature rises Tmu(x,y). The temperature at each pixel position is the temperature of the light emitting element at the pixel position. The temperature Tme(x,y) of each light emitting element is determined by adding the temperature rise Tmu(x,y) to the ambient temperature Tma, as shown in the following Equation (2):

Tme(x,y)=Tma+Tmu(x,y). Equation (2)

Instead of Equation (2), the element temperature estimator 13 may calculate the temperature Tme(x,y) by the following Equation (3). Equation (3) shows a calculation that, in determining the temperature Tme(x,y) of each light emitting element (the light emitting element of the pixel of interest), takes into account the effect of the temperature rises of light emitting elements located around the light emitting element (light emitting elements of pixels around the pixel of interest).

$$Tme ( x , y ) = Tma + {γ}_{1} \times Tmu ( x - 1 , y - 1 ) + {γ}_{2} \times Tmu ( x - 1 , y ) + {γ}_{3} \times Tmu ( x - 1 , y + 1 ) + {γ}_{4} \times Tmu ( x , y - 1 ) + {γ}_{5} \times Tmu ( x , y ) + {γ}_{6} \times Tmu ( x , y + 1 ) + {γ}_{7} \times Tmu ( x + 1 , y - 1 ) + {γ}_{8} \times Tmu ( x + 1 , y ) + {γ}_{9} \times Tmu ( x + 1 , y + 1 ) . \qquad Equation ( 3 )$$

In Equation (3), γ₁ to γ₉ are coefficients.

The calculation of Equation (3) takes into account pixels in a region consisting of 3×3 pixels centered on the pixel of interest, as the peripheral pixels.

Since the temperature rises of the peripheral pixels are determined from the weighted averages FA(x,y) for the respective pixels, the estimated value of the temperature of the light emitting element determined in consideration of the effect of the temperature rises of the peripheral pixels can be said to be an estimated value of the temperature of the light emitting element determined in consideration of the weighted averages FA(x,y) for the peripheral pixels.

In the above example, since the pixels in the region consisting of 3×3 pixels centered on the pixel of interest are taken into account, eight pixels are taken into account as the peripheral pixels. However, the number of pixels taken into account is not limited to eight, and may be nine or more or seven or less, and may be, for example, one.

As described above, the input image storage 12 holds the image data items of the last M+1 frames, and the element temperature estimator 13 estimates the temperatures of the light emitting elements on the basis of the image data items of the last M+1 frames output from the input image storage 12.

Here, M should be 1 or more. Thus, the input image storage 12 should hold image data items of multiple frames, and the element temperature estimator 13 should estimate the temperatures of the light emitting elements on the basis of the time series SE consisting of the image data items of the last multiple frames.

The compensation table storage 14 stores compensation tables for compensating variations in luminance and chromaticity with temperature.

The temperature variation compensator 15 corrects an image data item supplied from the image input unit 11 by referring to the compensation tables stored in the compensation table storage 4 in accordance with the temperatures estimated by the element temperature estimator 13.

The compensation is performed for each pixel.

The compensation is for cancelling the variations in luminance and chromaticity with the variations in temperature of the light emitting elements.

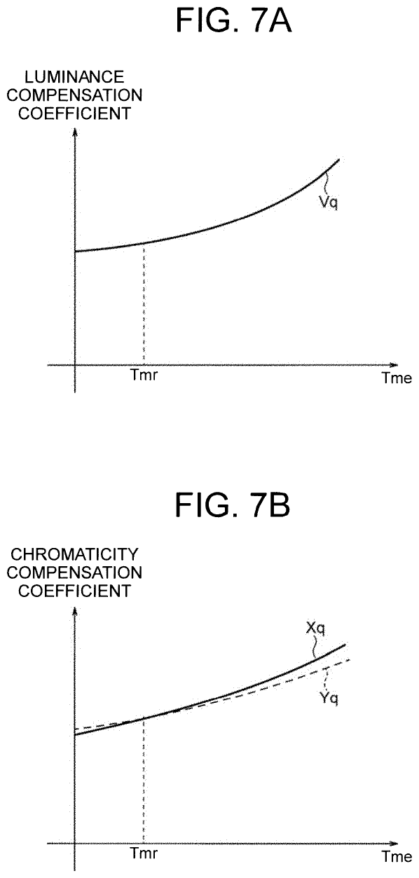

FIGS. 7A and 7B illustrate an example of relationships between inputs and outputs defined by the compensation tables stored in the compensation table storage 14. The relationships between the inputs and the outputs are represented by ratios of outputs to inputs, or coefficients. The coefficients are referred to as compensation coefficients.

For example, when the variation in the luminance with temperature is as shown in FIG. 2A, as a compensation table for luminance, one having the input-output relationship illustrated as an example in FIG. 7A, i.e., one whose variation with increase in temperature is opposite to that of FIG. 2A, is stored.

For example, the compensation table is formed by a compensation coefficient Vq that is equal to a reciprocal of a normalized value of the luminance Vp.

The normalized value mentioned here is the ratio to the luminance at a reference temperature. For example, in FIGS. 2A and 7A, when Tmr is taken as the reference temperature, the compensation coefficient Vq of FIG. 7A is 1 at the reference temperature Tmr.

Similarly, when the variations in the X and Y stimulus values representing the chromaticity with temperature is as shown in FIG. 2B, as compensation tables, ones having the input-output relationships illustrated as an example in FIG. 7B, i.e., ones whose variations with increase in temperature are opposite to those of FIG. 2B, are stored.

For example, a compensation table for the X stimulus value is formed by a compensation coefficient Xq that is equal to a reciprocal of a normalized value of the X stimulus value Xp. Similarly, a compensation table for the Y stimulus value is formed by a compensation coefficient Yq that is equal to a reciprocal of a normalized value of the Y stimulus value Yp.

The normalized values mentioned here are the ratios to the X and Y stimulus values at a reference temperature. For example, in FIGS. 2B and 7B, when Tmr is taken as the reference temperature, the compensation coefficients Xq and Yq of FIG. 7B are 1 at the reference temperature Tmr.

The variations in luminance and chromaticity with temperature may differ between the light emitting elements. In this case, values representing average variations are used as the curves representing the luminance and chromaticity of FIGS. 2A and 2B. For example, values obtained by averaging the variations of a large number of light emitting elements are used, and as the compensation tables indicating the compensation coefficients of FIGS. 7A and 7B, tables for compensating such average variations are generated.

The compensation tables are assumed to have values of the compensation coefficients for each of the values that can be taken by the temperature Tme of the light emitting element. However, this is not mandatory. Specifically, it is possible to discretely hold values of the compensation coefficients for the temperatures Tme of the light emitting element, and determine, by interpolation, the corresponding values of the compensation coefficients for temperatures Tme of the light emitting element for which no values of the compensation coefficients are held. The interpolation can be performed by using the values of the compensation coefficients corresponding to the values (table points) of the temperature Tme having the values of the compensation coefficients, for example.

The temperature variation compensator 15 generates and outputs a compensated image data item Db corresponding to an input image Di on the basis of the compensation tables stored in the compensation table storage 14 and the temperatures Tme of the respective light emitting elements.

For the compensation of chromaticity, the image data is corrected on the basis of the compensation coefficients for the X and Y stimulus values so that the amounts of light emitted from the red, green, and blue LEDs are adjusted.

The image output unit 16 converts the image data item Db output from the temperature variation compensator 15 to a signal in a format according to the display system of the image display 2, and outputs the converted image signal Do.

When the light emitting elements of the image display 2 emit light under pulse width modulation (PWM) drive, grayscale values of the image data item are converted to PWM signals.

The image display 2 displays an image on the basis of the image signal Do. The displayed image is one in which the variations in luminance and chromaticity with temperature have been compensated for each pixel. Thus, an image free from unevenness in luminance and color is displayed.

The above calculation of the estimated values Tme of the temperatures of the light emitting elements based on the time series SE of the image data items of the M+1 frames, the determination of the compensation coefficients Vq, Xq, and Yq based on the calculated estimated values, and the compensation of the image data using the determined compensation coefficients may be performed every M+1 frames, may be performed with a period greater than M+1 frames, or may be performed with a period less than M+1 frames. For example, they may be performed every frame.

In any of the cases, the estimated values of the temperatures of the light emitting elements should be determined at each time by using the image data item of the currently input frame and the image data items of the preceding M frames.

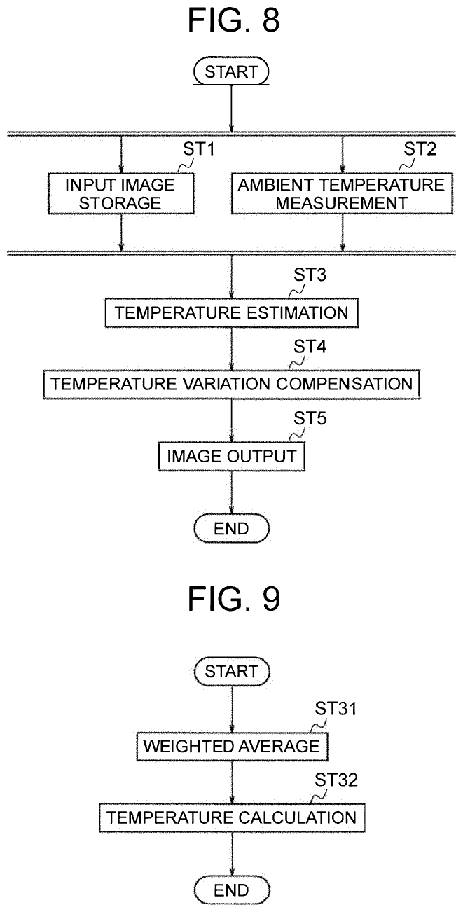

The procedure of a process by the processor 91 when the above image processing device 1 is formed by the computer of FIG. 3 will be described with reference to FIGS. 8 and 9.

In FIG. 8, in step ST1, input images are stored. This process is the same as the process by the input image storage 12 of FIG. 1.

In step ST2, the ambient temperature is measured. This process is the same as the process by the ambient temperature measurement unit 3 of FIG. 1. The process of step ST2 can be performed in parallel with the process of step ST1.

In step ST3, the temperatures of the respective light emitting elements are estimated. This process is the same as the process by the element temperature estimator 13 of FIG. 1.

In step ST4, the temperature variation compensation is performed. This process is the same as the process by the temperature variation compensator 15 of FIG. 1.

In step ST5, the image output is performed. This process is the same as the process by the image output unit 16 of FIG. 1.

FIG. 9 details step ST3 of FIG. 8.

In step ST31 of FIG. 9, the weighted averages are calculated. This process is the same as the process by the average calculator 32 of FIG. 5.

In step ST32, the temperatures of the light emitting elements are calculated. This process is the same as the process by the temperature calculator 34 of FIG. 5.

As described above, the weight set WS stored in the weight storage 31 and the conversion table CA stored in the conversion table storage 33 are determined or generated by machine learning.

A learning device for the machine learning is connected to the image display device of FIG. 1 and used.

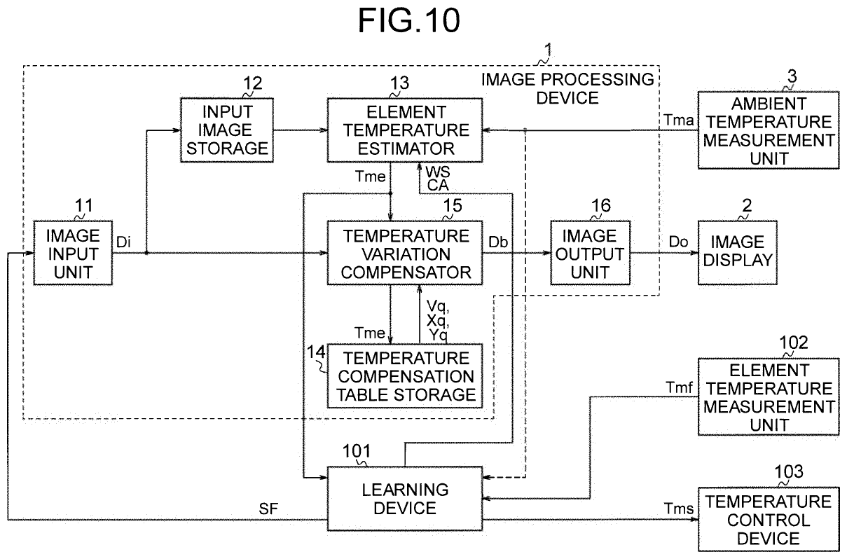

FIG. 10 illustrates the learning device 101 connected to the image display device of FIG. 1. FIG. 10 also illustrates an element temperature measurement unit 102 and a temperature control device 103 that are used together with the learning device 101.

The element temperature measurement unit 102 includes multiple temperature sensors. The multiple temperature sensors are provided to correspond to the multiple light emitting elements constituting the image display 2, and each temperature sensor measures and outputs a temperature Tmf of the corresponding light emitting element.

Each temperature sensor may be of a contact type or a non-contact type.

The contact type temperature sensor may be formed by a thermistor or a thermocouple, for example.

The non-contact type temperature sensor may detect a surface temperature by receiving infrared light.

Also, the element temperature measurement unit 102 may include a single thermal image sensor, measure a temperature distribution of a display screen of the image display 2, and determine the temperature of each light emitting element by associating positions in the thermal image with positions on the display screen of the image display 2.

The temperature control device 103 maintains the ambient temperature of the image display 2 at a set value Tms specified by the learning device 101. The temperature control device 103 is formed by, for example, an air conditioner, and maintains the temperature of a space in which the image display 2 is located, at the set value Tms.

The learning device 101 may be formed by a computer. When the image processing device 1 is formed by a computer, the same computer may form the learning device 101. The computer that forms the learning device 101 may be, for example, one illustrated in FIG. 3. In this case, the function of the learning device 101 may be implemented by the processor 91 executing a program stored in the memory 92.

The learning device 101 causes the image processing device 1 to operate, and performs learning so that the temperatures (estimated values) Tme of the light emitting elements calculated by the element temperature estimator 13 are close to the temperatures (measured values) Tmf of the light emitting elements measured by the element temperature measurement unit 102.

Multiple learning input data sets LDS each constituted by a set value Tms of the ambient temperature and a time series SF of image data items are used for the learning.

The learning device 101 inputs the time series SF of image data items included in the learning input data sets LDS to the image input unit 11, obtains the estimated values Tme of the temperatures of the light emitting elements calculated by the element temperature estimator 13 and the measured values Tmf of the temperatures of the light emitting elements measured by the element temperature measurement unit 102, and performs learning so that the estimated values Tme are close to the measured values Tmf.

The time series SF of image data items constituting the learning input data sets LDS are each constituted by image data items of the same number of frames as the number (M+1) of frames of the image data items constituting the time series SE used in the temperature estimation by the element temperature estimator 13 when the image display device performs image display.

At least one of the set value Tms of the ambient temperature and the time series SF of image data items is different between the multiple learning input data sets LDS.

The determination of the weight set WS and the generation of the conversion table CA by learning can be performed by the following first or second method, for example.

In the first method, the weight set WS and conversion table CA are determined so that a difference of the estimated values Tme of the temperatures of the light emitting elements from the measured values Tmf is minimized.

Specifically, the previously prepared multiple learning input data sets LDS are sequentially selected, differences between the measured values Tmf of the temperatures of the light emitting elements and the estimated values Tme are determined as errors ER when the ambient temperature is maintained at the set value Tms of the ambient temperature of the selected learning input data set and the time series SF of image data items of the selected learning input data set LDS is input, a sum ES of the errors ER for the multiple learning input data sets LDS is determined as a cost function, and the weight set WS and conversion table CA are determined by learning so that the cost function is minimized.

In the second method, the conversion table CA is first generated, and then the weight set WS is determined.

In generation of the conversion table CA, for each of multiple grayscale values, a temperature Tmf of light emitting element(s) and the ambient temperature Tma are measured when a time series SF of image data items in which pixel values are fixed at the grayscale value is input, and a temperature rise Tmu is calculated from the measurement results, and the conversion table CA is generated from a relationship between the grayscale values and the temperature rises for the multiple grayscale values. At this time, the temperature variation compensator 15 simply supplies the image data items output from the image input unit 11 to the image output unit 16 without performing the temperature variation compensation. Specifically, the learning device 101 performs control so that the temperature variation compensator 15 operates in such a manner.

The image data items in which pixel values are fixed at a certain grayscale value may be image data items in which only the pixel values of a specific light emitting element are fixed at the grayscale value, or may be image date items in which the pixel values of multiple light emitting elements, e.g., the pixel values of all the light emitting elements constituting the image display 2, are fixed at the grayscale value. In the case of using image data items in which the pixel values of multiple light emitting elements are fixed at the grayscale value, it is possible to use, as the above temperature of light emitting element(s), the temperature of one of the light emitting elements or an average of the temperatures of the multiple light emitting elements.

When the conversion table CA is generated by the second method, the learning device 101 needs to be notified of the measured value Tmf from the ambient temperature measurement unit 3. This is because the measured value of the ambient temperature is used to calculate the temperature rise, as described above. The notification of the measured value from the ambient temperature measurement unit 3 to the learning device 101 is represented by a dotted line in FIG. 10.

It is preferable to keep the ambient temperature constant when inputting a time series SF of image data items in which pixel values are fixed and obtaining the measured value Tmf of the temperature(s) of the light emitting element(s) in order to generate the conversion table CA, but this is not mandatory. It is sufficient that the temperature rise Tmu can be determined from the measured value Tma of the ambient temperature and the measured value Tmf of the temperature(s) of the light emitting element(s).

In determination of the weight set WS in the second method, the weight set WS is determined so that a difference of the estimated values Tme of the temperatures of the light emitting elements calculated by using the conversion table CA generated as described above from the measured values Tmf is minimized.

Specifically, the previously prepared multiple learning input data sets LDS are sequentially selected, differences between the measured values Tmf of the temperatures of the light emitting elements and the estimated values Tme are determined as errors ER when the ambient temperature is maintained at the set value Tms of the ambient temperature of the selected learning input data set LDS and the time series SF of image data items of the selected learning input data set LDS is input, a sum ES of the errors ER for the multiple learning input data sets LDS is determined as a cost function, and the weight set WS is determined by learning so that the cost function is minimized.

In each of the above first and second methods, it is possible to use, as the sum ES of the errors ER, a sum of absolute values of the errors ER or a sum of squares of the errors ER.

Also, control for maintaining the ambient temperature at the set value Tms is performed by the learning device 101 notifying the temperature control device 103 of the set value Tms and the temperature control device 103 operating to maintain the ambient temperature at the set value Tms.

When the learning is completed, the temperature sensors of the element temperature measurement unit 102 are removed, and the image display device is used for image display with the temperature sensors removed.

Thus, when being used for image display, the image display device needs no temperature sensors that detect the temperatures of the light emitting elements. This is because the temperatures of the light emitting elements can be estimated by the element temperature estimator 13 without temperature sensors that detect the temperatures of the light emitting elements.

After completion of the learning, the learning device 101 may be removed, or may remain attached.

In particular, when the function of the learning device 101 is implemented by execution of a program by the processor 91, the program may remain stored in the memory 92.

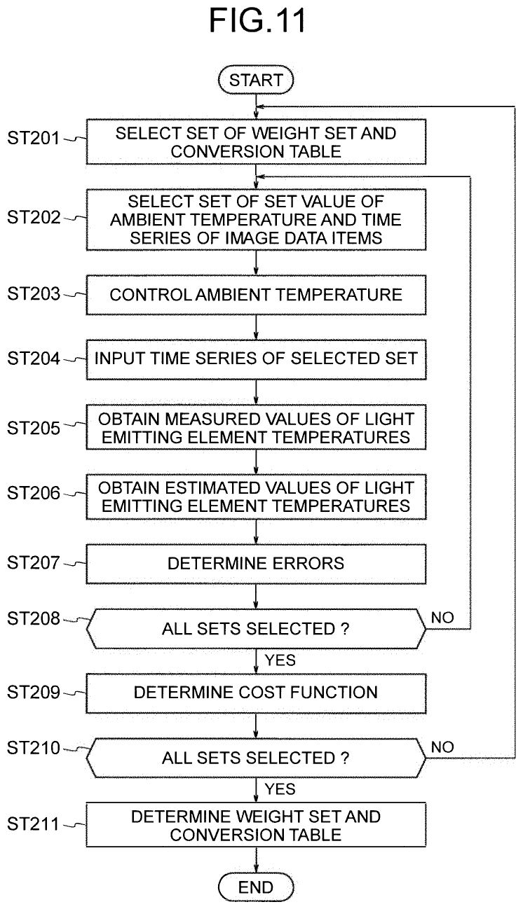

The procedure of a process by the processor 91 when the above learning device 101 is formed by the computer of FIG. 3 will be described with reference to FIGS. 11, 12, and 13.

FIG. 11 illustrates the procedure of a process when the above first method is used.

In step ST201, the learning device 101 selects one of previously prepared multiple sets each including a weight set WS and a conversion table CA. The learning device 10 temporarily sets the weight set WS of the selected set in the weight storage 31, and temporarily sets the conversion table CA of the selected set in the conversion table storage 33.

In step ST202, the learning device 101 selects one of previously prepared multiple sets each including a set value Tms of the ambient temperature and a time series SF of image data items.

In step ST203, the learning device 101 performs temperature control so that the ambient temperature is maintained at the set value Tms of the ambient temperature of the set selected in step ST202. Specifically, the learning device 101 causes the temperature control device 103 to perform the temperature control.

In step ST204, the learning device 101 inputs the time series SF of image data items of the set selected in step ST202. Specifically, the learning device 101 inputs the time series SF of image data items to the image input unit 11. The input time series SF of image data items is supplied to the element temperature estimator 13 through the input image storage 12 and is supplied to the temperature variation compensator 15.

In step ST205, the learning device 101 obtains the measured values Tmf of the temperatures of the light emitting elements. The measured values Tmf obtained here are values measured by the element temperature measurement unit 102, and measured values of the temperatures of the light emitting elements when the ambient temperature is controlled at the set value Tms of the ambient temperature of the selected set, the time series SF of image data items of the selected set is input, and the image display 2 displays images in accordance with the image data items included in the time series SF.

In step ST206, the learning device 101 obtains the estimated values Tme of the light emitting element temperatures. The estimated values Tme obtained here are estimated values calculated by the element temperature estimator 13 using the selected weight set WS and conversion table CA when the ambient temperature is controlled at the set value Tms of the ambient temperature of the selected set and the time series SF of image data items of the selected set is input. The selected weight set WS is the weight set WS temporarily set in the weight storage 31, and the selected conversion table CA is the conversion table CA temporarily set in the conversion table storage 33.

In step ST207, the learning device 101 determines, as errors ER, differences between the measured values Tmf obtained in step ST205 and the estimated values Tme obtained in step ST206.

In step ST208, the learning device 101 determines whether the process of steps ST202 to ST207 has been completed for all the above multiple sets each including a set value Tms of the ambient temperature and a time series SF of image data items.

When the above process has not been completed for all the multiple sets, it returns to step ST202.

Then, in step ST202, a next set of a set value Tms of the ambient temperature and a time series SF of image data items is selected, and in steps ST203 to ST207, for the selected set, the same process as described above is repeated, so that the errors ER are determined.

When the process of steps ST203 to ST207 has been completed for all the multiple sets in step ST208, it proceeds to step ST209.

In step ST209, the learning device 101 determines a sum ES of the above errors ER (a sum for the multiple sets) as a cost function.

As the sum ES of the errors ER, it is possible to use a sum of absolute values of the errors ER or a sum of squares of the errors ER.

Then, in step ST210, the learning device 101 determines whether all the multiple sets each including a weight set WS and a conversion table CA have been selected.

When not all the sets have been selected, it returns to step ST201.

In this case, in step ST201, one of the sets each including a weight set WS and a conversion table CA that has not yet been selected is selected.

When all the sets have been selected in step ST210, it proceeds to step ST211.

In step ST211, the learning device 101 employs, as an optimum set, the set of the weight set WS and conversion table CA at which the cost function determined in step ST209 is minimum.

The learning device 101 writes the weight set WS of the employed set to the weight storage 31, and writes the conversion table CA of the employed set to the conversion table storage 33.

This is the end of the process of optimizing the set of the weight set and conversion table.

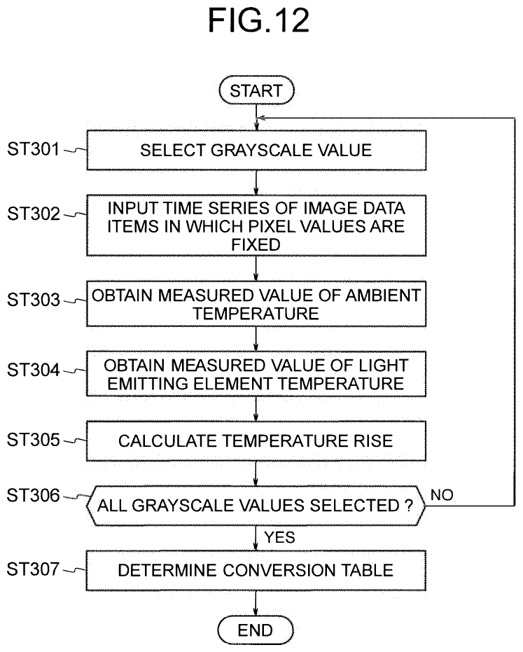

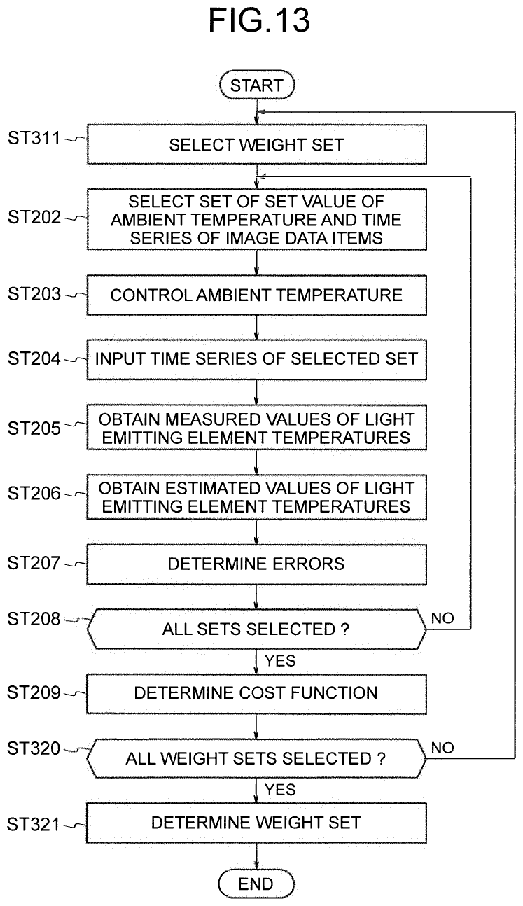

FIGS. 12 and 13 illustrate the procedure of a process when the above second method is used.

The conversion table CA is determined in steps ST301 to ST307 illustrated in FIG. 12, and the weight set WS is determined in steps ST311 to ST320 illustrated in FIG. 13.

First, in step ST301 of FIG. 12, the learning device 101 selects one of previously prepared multiple grayscale values.

In step ST302, the learning device 101 inputs a time series of image data items in which pixel values are fixed, to the image input unit 11. In addition, the learning device 101 controls the temperature variation compensator 15 to place the temperature variation compensator 15 in a state in which it simply supplies the input from the image input unit 11 to the image output unit 16 without performing the temperature variation compensation. Each of the input image storage 12 and element temperature estimator 13 may be active or inactive.

In step ST303, the learning device 101 obtains the measured value Tma of the ambient temperature. The measured value Tma obtained here is a measured value produced by the ambient temperature measurement unit 3.

In step ST304, the learning device 101 obtains a measured value Tmf of the temperature(s) of light emitting element(s). The measured value Tmf obtained here is a measured value produced by the element temperature measurement unit 102, and is a measured value of the temperature(s) of light emitting element(s) when the time series of image data items having the selected grayscale value is input and the image display 2 displays images in accordance with the image data items in which pixel values are fixed at the selected grayscale value.

As described above, image data items in which pixel values are fixed at a certain grayscale value may be image data items in which only the pixel values of a specific light emitting element are fixed at the grayscale value, or may be image data items in which the pixel values of multiple light emitting elements, e.g., the pixel values of all the light emitting elements constituting the image display 2, are fixed at the grayscale value. When image data items in which the pixel values of multiple light emitting elements are fixed at the grayscale value are input, it is possible to obtain, as the above measured value of the temperature(s) of light emitting element(s), the temperature of one of the light emitting elements or an average of the temperatures of the multiple light emitting elements.

In step ST305, the learning device 101 calculates a temperature rise Tmu from the measured values Tma and Tmf obtained in steps ST303 and ST304. The temperature rise Tmu is determined by subtracting the measured value Tma of the ambient temperature from the measured value Tmf of the temperature(s) of the light emitting element(s).

In step ST306, the learning device 101 determines whether all the previously prepared multiple grayscale values have been selected.

When not all the grayscale values have been selected, it returns to step ST301.

In this case, in step ST301, one of the multiple grayscale values that has not yet been selected is selected.

In step ST306, when all the multiple grayscale values have been selected, it proceeds to step ST307.

In step ST307, from the multiple grayscale values and the temperature rises Tmu calculated for the multiple grayscale values, the learning device 101 determines the conversion table CA indicating a relationship between the weighted average FA and the temperature rise Tmu.

When images in which pixel values are fixed are continuously input, the weighted average FA is equal to the fixed grayscale value. Thus, a relationship between the grayscale value and the temperature rise Tmu is equivalent to the relationship between the weighted average FA and the temperature rise Tmu, and the conversion table CA can be determined from the relationship between the grayscale value and the temperature rise.

The learning device 101 writes the determined conversion table CA to the conversion table storage 33.

In step ST311 of FIG. 13, the learning device 101 selects one of previously prepared multiple weight sets WS. The learning device 101 temporarily sets the selected weight set WS in the weight storage 31.

The process of steps ST202 to ST209 is the same as the process of steps ST202 to ST209 of FIG. 11.

Specifically, in step ST202, one of the previously prepared multiple sets each including a set value Tms of the ambient temperature and a time series SF of image data items is selected.

In step ST203, temperature control is performed so that the ambient temperature is maintained at the set value Tms of the ambient temperature of the set selected in step ST202.

In step ST204, the time series SF of image data items of the set selected in step ST202 is input.

In step ST205, the measured values Tmf of the temperatures of the light emitting elements are obtained.

In step ST206, the estimated values Tme of the temperatures of the light emitting elements are obtained.

In step ST207, differences between the measured values Tmf and the estimated values Tme are determined as errors ER.

In step ST208, it is determined whether the process of steps ST202 to ST207 has been completed for all the multiple sets each including a set value Tms of the ambient temperature and a time series SF of image data items.

When the above process has been completed for all the multiple sets, it proceeds to step ST209.

In step ST209, a sum ES of the above errors ER (a sum for the multiple sets) is determined as a cost function.

In step ST320, it is determined whether all the weight sets WS have been selected.

When not all the weight sets have been selected, it proceeds to step ST321.

In step ST321, the weight set WS at which the cost function determined in the above step ST209 is minimum is employed as an optimum set.

This is the end of the process of optimizing the weight set.

As above, the image processing device according to the first embodiment does not require an image display device including the image processing device to include a temperature sensor for each light emitting element, and can estimate the temperatures of the respective light emitting elements, and prevent the occurrence of unevenness in luminance and chromaticity due to temperature variation.

### Second Embodiment

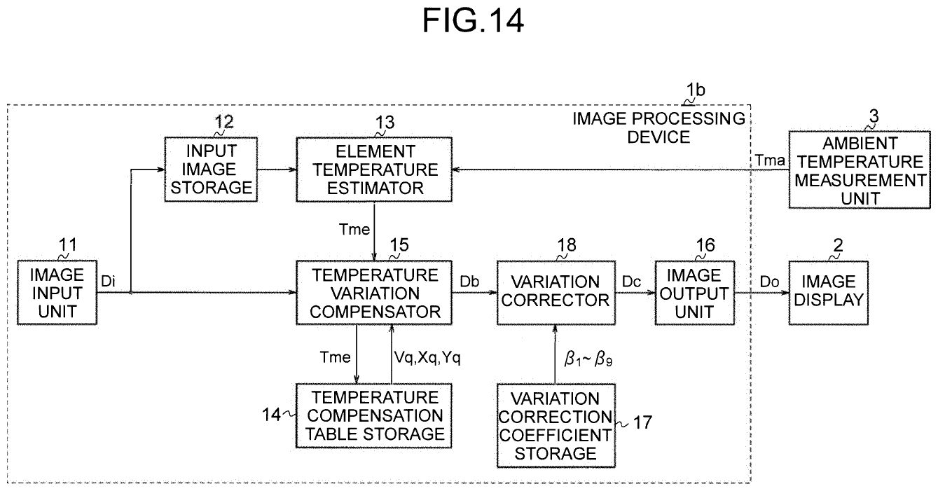

FIG. 14 is a diagram illustrating an image display device including an image processing device 1b of a second embodiment of the present invention.

The image processing device 1b illustrated in FIG. 14 is generally the same as the image processing device 1 of FIG. 1, but additionally includes a variation correction coefficient storage 17 and a variation corrector 18.

The image processing device 1b may be formed by, for example, the computer illustrated in FIG. 3, as with the image processing device 1.

There is variation in the luminance or chromaticity of the generated light between the light emitting elements.

The variation correction coefficient storage 17 stores at least one variation correction coefficient for each light emitting element, specifically at least one coefficient for correcting the variation in luminance and color for each light emitting element. For example, it holds nine correction coefficients β₁ to β₉ for each light emitting element.

On the basis of the image data item Db output from the temperature variation compensator 15 and the correction coefficients β₁ to β₉ stored in the variation correction coefficient storage 17, the variation corrector 18 generates and outputs an image data item Dc in which the variation between the light emitting elements has been corrected, by performing calculations shown in the following Equations (4a), (4b), and (4c):

$$\begin{matrix}Rc ( x , y ) = {β}_{1} ( x , y ) \times Rb ( x , y ) + {β}_{2} ( x , y ) \times Gb ( x , y ) + {β}_{3} ( x , y ) \times Bb ( x , y ) , & Equation ( 4 a ) \\ Gc ( x , y ) = {β}_{4} ( x , y ) \times Rb ( x , y ) + {β}_{5} ( x , y ) \times Gb ( x , y ) + {β}_{6} ( x , y ) \times Bb ( x , y ) , & Equation ( 4 b ) \\ Bc ( x , y ) = {β}_{7} ( x , y ) \times Rb ( x , y ) + {β}_{8} ( x , y ) \times Gb ( x , y ) + {β}_{9} ( x , y ) \times Bb ( x , y ) . & Equation ( 4 c )\end{matrix}$$

In Equations (4a) to (4c),

Rb(x,y), Gb(x,y), and Bb(x,y) denote the red, green, and blue pixel values of the pixel of interest of the image data item Db input to the variation corrector 18;

Rc(x,y), Gc(x,y), and Bc(x,y) denote the red, green, and blue pixel values of the corrected image data item Dc output from the variation corrector 18; and

β₁(x,y) to β₉(x,y) denote the correction coefficients for the pixel of interest.

The image output unit 16 converts the image data item Dc output from the variation corrector 18 to a signal in a format according to the display system of the image display 2, and outputs the converted image signal Do.

When the light emitting elements of the image display 2 emit light under pulse width modulation (PWM) drive, grayscale values of the image data item are converted to PWM signals.

The image display 2 displays an image on the basis of the image signal Do. The displayed image is one in which the variations in luminance and chromaticity with temperature have been compensated for each pixel and the variation between the light emitting elements has been corrected. Thus, an image free from unevenness in luminance and color is displayed.

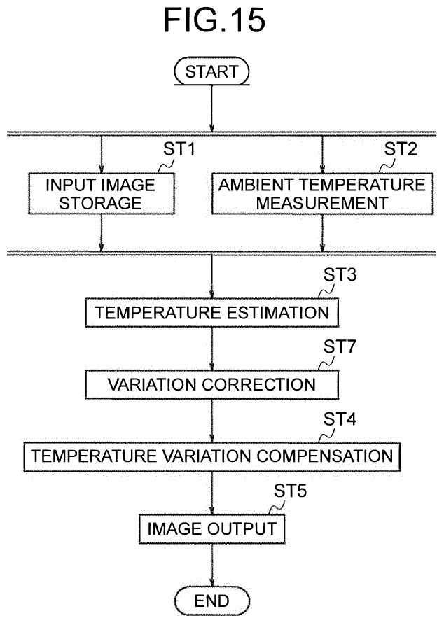

The procedure of a process by the processor 91 when the above image processing device 1b is formed by the computer of FIG. 3 will be described with reference to FIG. 15.

FIG. 15 is generally the same as FIG. 8, but additionally includes step ST7.

In step ST7, the variation correction is performed. This process is the same as the process by the variation corrector 18 of FIG. 14.

The weight set WS and conversion table CA used in the element temperature estimator 13 of the image processing device 1b of the second embodiment are determined by the same machine learning as described in the first embodiment.

As above, the image processing device according to the second embodiment does not require an image display device including the image processing device to include a temperature sensor for each light emitting element, and can estimate the temperatures of the respective light emitting elements, and prevent the occurrence of unevenness in luminance and chromaticity due to temperature variation, as with the first embodiment. In addition, it is possible to correct variation between the light emitting elements.

### Third Embodiment

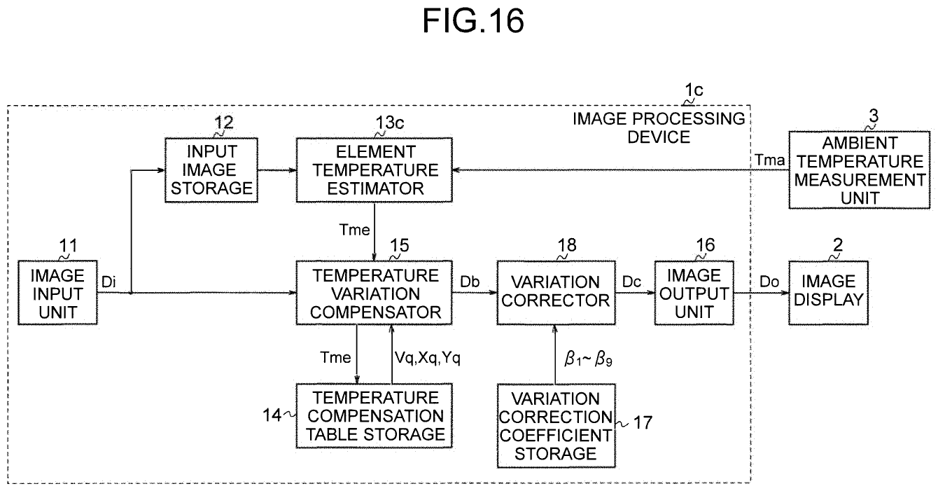

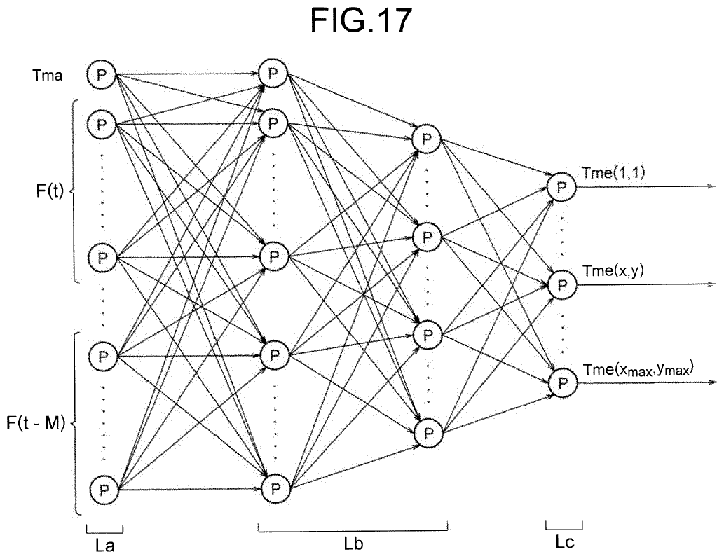

FIG. 16 is a diagram illustrating an image display device including an image processing device 1c of a third embodiment of the present invention.

The image processing device 1c illustrated in FIG. 16 is generally the same as the image processing device 1b of FIG. 14, but includes an element temperature estimator 13c instead of the element temperature estimator 13.

The image processing device 1c may be partially or wholly formed by processing circuitry, as with the image processing device 1b. The processing circuitry may be implemented by hardware, or by software or a programmed computer.

It is possible that a part of the functions of respective portions of the image processing device 1c is implemented by hardware and another part is implemented by software.

When the image processing device 1c is formed by a computer, the computer may be, for example, one illustrated in FIG. 3.

The element temperature estimator 13c estimates the temperatures of the respective light emitting elements on the basis of the ambient temperature Tma measured by the ambient temperature measurement unit 3 and the time series of image data items that is constituted by the image data items of the multiple frames and output from the input image storage 12, and outputs the estimated values Tme.

The element temperature estimator 13c is formed by a neural network. An example of such a neural network is illustrated in FIG. 17.

The illustrated neural network receives, as inputs, the ambient temperature Tma measured by the ambient temperature measurement unit 3 and the time series of image data items (the pixel values represented by the image data items constituting the time series) output from the input image storage 12, and outputs estimated values of the temperatures of the respective light emitting elements of the image display 2.

The illustrated neural network includes an input layer La, intermediate layers (hidden layers) Lb, and an output layer Lc. Although in the illustrated example, the number of intermediate layers is two, it may be one or three or more.

Each neuron P of the input layer La is assigned the ambient temperature Tma or one of the pixel values represented by the image data items constituting the time series, and each neuron receives the ambient temperature Tma or pixel value assigned thereto. Each neuron of the input layer La simply outputs the input.

The neurons P of the output layer Lc are provided to correspond to the respective light emitting elements of the image display 2. Each neuron P of the output layer Lc consists of multiple bits, e.g., 10 bits, and outputs data indicating a temperature estimated value of the corresponding light emitting element.

In FIG. 17, the temperature estimated values of the light emitting elements at pixel positions (1,1) to (xₘₐₓ, yₘₐₓ) are denoted by the symbols Tme(1,1) to Tme (xₘₐₓ, yₘₐₓ).

(1,1) denotes a pixel position at a left upper corner of the display screen, and (xₘₐₓ, yₘₐₓ) denotes a pixel position at a right lower corner of the display screen.

The neurons P of the intermediate layers Lb and output layer Lc each perform the calculation represented by the following model equation on multiple inputs:

y=s(w₁×x₁+w₂×x₂+ . . . +w_{N}×x_{N}+b). Equation (5)

In Equation (5), N is the number of inputs to the neuron P, and may differ between the neurons.

x₁ to x_{N} are input data to the neuron P;

w₁ to w_{N} are weights for the inputs x₁ to x_{N}; and

b is a bias.

The weights and bias are determined by learning.

Hereinafter, the weights and bias will be collectively referred to as parameters.

The function s(a) is an activation function.

The activation function may be, for example, a step function that outputs 0 if a is 0 or less and outputs 1 otherwise.

The activation function s(a) may be a ReLU function that outputs 0 if a is 0 or less and outputs the input value a otherwise, an identify function that simply outputs the input value a, or a sigmoid function.

Since the neurons of the input layer La simply output the inputs as described above, activation functions used in the neurons of the input layer La can be said to be identify functions.

For example, it is possible that step functions or sigmoid functions are used in the intermediate layers Lb and ReLU functions are used in the output layer. Also, it is possible that different activation functions are used in the neurons in the same layer.

The number of neurons P and the number of layers (the number of stages) are not limited to those in the example illustrated in FIG. 17.

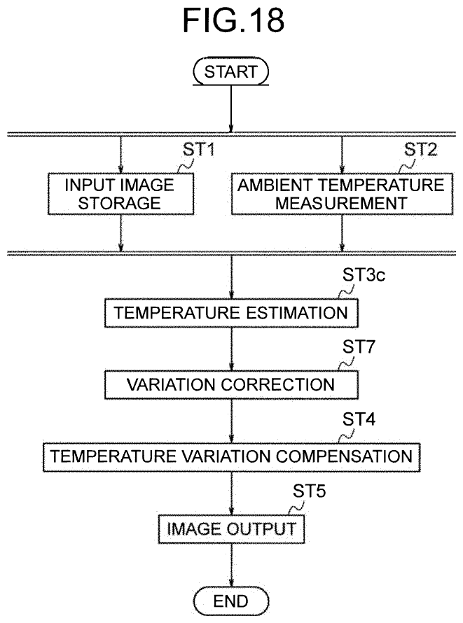

The procedure of a process by the processor 91 when the above image processing device 1c is formed by the computer of FIG. 3 will be described with reference to FIG. 18.

FIG. 18 is generally the same as FIG. 15, but includes step ST3c instead of step ST3.

In step ST3c, the temperatures of the respective light emitting elements are estimated. This process is the same as the process by the element temperature estimator 13c of FIG. 16.

The neural network forming the element temperature estimator 13c is generated by machine learning.

A learning device for the machine learning is connected to the image display device of FIG. 16 and used.

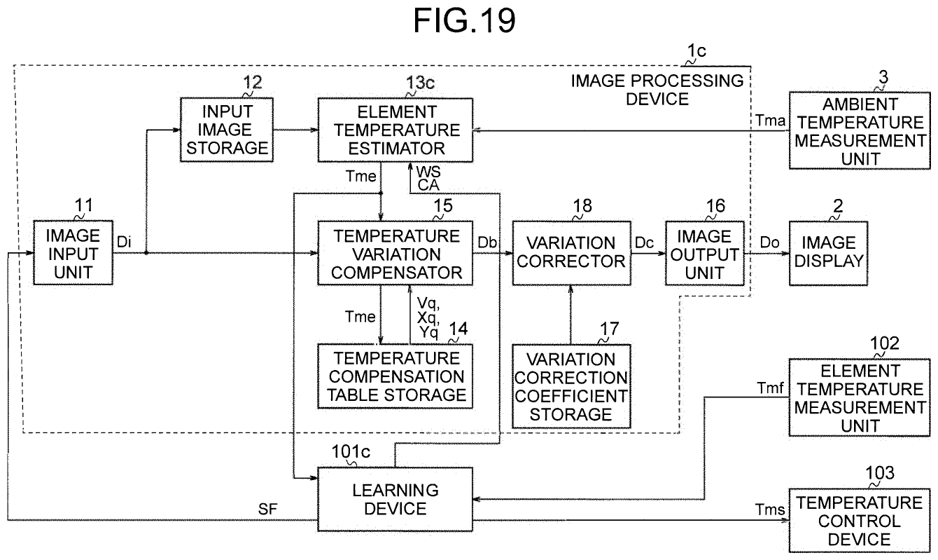

FIG. 19 illustrates the learning device 101c connected to the image display device of FIG. 1. FIG. 19 also illustrates an element temperature measurement unit 102 and a temperature control device 103 that are used together with the learning device 101c.

The element temperature measurement unit 102 and temperature control device 103 are the same as described in the first embodiment.

The learning device 101c may be formed by a computer. When the image processing device 1c is formed by a computer, the same computer may form the learning device 101c. The computer that forms the learning device 101c may be, for example, one illustrated in FIG. 3. In this case, the function of the learning device 101c may be implemented by the processor 91 executing a program stored in the memory 92.

The learning device 101c causes the image processing device 1c to operate, and performs learning so that the temperatures (estimated values) Tme of the light emitting elements calculated by the element temperature estimator 13c are close to the temperatures (measured values) Tmf of the light emitting elements measured by the element temperature measurement unit 102.

Multiple learning input data sets LDS each constituted by a set value Tms of the ambient temperature and a time series SF of image data items are used for the learning.

The learning device 101c sequentially selects the previously prepared multiple learning input data sets LDS, causes the temperature control device 103 to perform control to maintain the ambient temperature at the set value Tms of the ambient temperature included in the selected learning input data set LDS, inputs the time series SF of image data items included in the selected learning input data set LDS to the image input unit 11, obtains the estimated values Tme of the temperatures of the light emitting elements calculated by the element temperature estimator 13c and the measured values Tmf of the temperatures of the light emitting elements measured by the element temperature measurement unit 102, and performs learning so that the estimated values Tme are close to the measured values Tmf.

The time series SF of image data items constituting the learning input data sets LDS are each constituted by image data items of the same number of frames as the number (M+1) of frames of the image data items used in the temperature estimation by the element temperature estimator 13c when the image display device performs image display.

At least one of the set value Tms of the ambient temperature and the time series SF of image data items is different between the multiple learning input data sets LDS.

In generation of the neural network by the learning device 101c, an original neural network is first prepared. Specifically, the element temperature estimator 13c is temporarily constructed by an original neural network. This neural network is the same as the neural network illustrated in FIG. 17, and each of the neurons of the intermediate layers and output layer is connected to all the neurons of the preceding layer.

In generation of the neural network, it is necessary to determine the values of the parameters (the weights and bias) for each of the multiple neurons. A set of the parameters for the multiple neurons will be referred to as a parameter set, and denoted by the symbol PS.

In generation of the neural network, the parameter set PS is optimized by using the original neural network so that a difference of the estimated values Tme of the temperatures of the light emitting elements from the measured values Tmf is minimized. The optimization can be performed by, for example, an error back-propagation algorithm.

Specifically, predetermined multiple learning input data sets LDS each constituted by a set value Tms of the ambient temperature and a time series SF of image data items are prepared; initial values of the parameter set PS are set; the above learning input data sets LDS are sequentially selected; differences between the measured values Tmf of the temperatures of the light emitting elements and the estimated values Tme are determined as errors ER when the ambient temperature is maintained at the set value Tms of the ambient temperature of the selected learning input data set LDS and the time series SF of image data items of the selected learning input data set LDS is input; a sum ES of the errors ER for the multiple learning input data sets LDS is determined as a cost function, and when the cost function is more than a threshold, changes the parameter set PS to reduce the cost function. The above process is repeated until the cost function becomes not more than the threshold. The change of the parameter set PS can be performed by a gradient descent method.

As the sum ES of the errors ER, it is possible to use a sum of absolute values of the errors ER or a sum of squares of the errors ER.

After the optimization of the parameter set PS, synaptic connections (connections between neurons) whose weights are zero are broken.

When the learning is completed, the temperature sensors of the element temperature measurement unit 102 are removed, and the image display device is used with the temperature sensors removed.

Thus, when being used for image display, the image display device needs no temperature sensors that detect the temperatures of the light emitting elements. This is because the temperatures of the light emitting elements can be estimated by the element temperature estimator 13c without temperature sensors that detect the temperatures of the light emitting elements.

After completion of the learning, the learning device 101c may be removed, or may remain attached.

In particular, when the function of the learning device 101c is implemented by execution of a program by the processor 91, the program may remain stored in the memory 92.

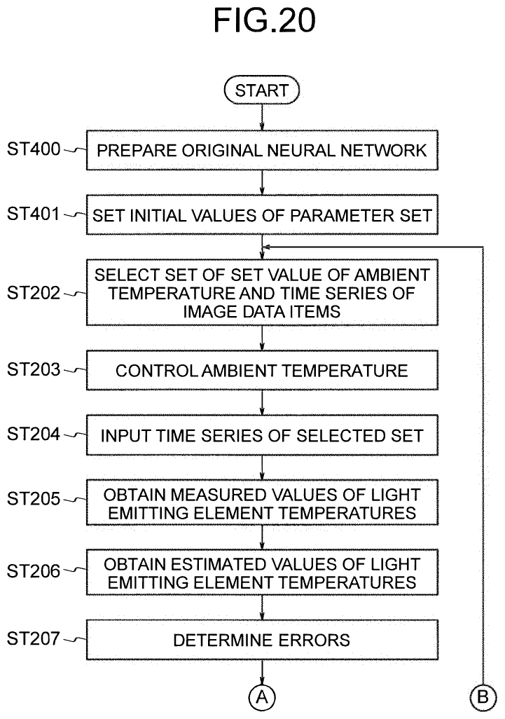

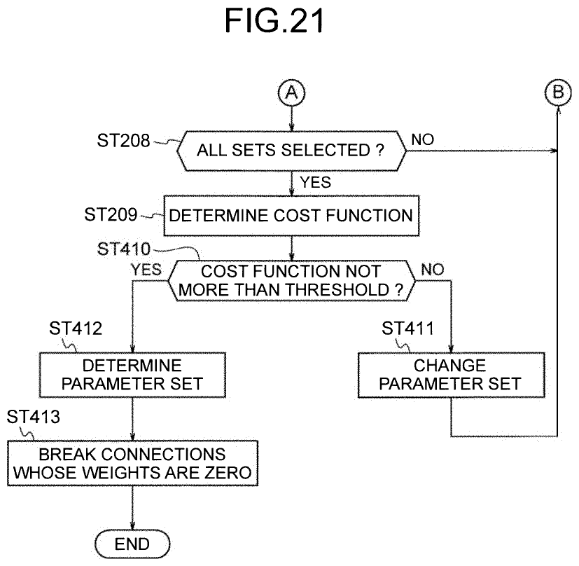

The procedure of a process by the processor 91 when the above learning device 101c is formed by the computer of FIG. 3 will be described with reference to FIGS. 20 and 21.

In step ST400 of FIG. 20, the learning device 101c prepares an original neural network. Specifically, the element temperature estimator 13c is temporarily constructed by using an original neural network.

The neural network is the same as the neural network illustrated in FIG. 17, and each of the neurons of the intermediate layers and output layer is connected to all the neurons of the preceding layer.

In step ST401, the learning device 101c sets initial values of the set PS of the parameters (the weights and bias) used in the calculations in the respective neurons of the intermediate layers and output layer of the neural network prepared in step ST400.

The initial values may be randomly selected values or values expected to be appropriate.

The process of steps ST202 to ST209 is the same as the process of steps ST202 to ST209 of FIG. 11.

Specifically, in step ST202, the learning device 101c selects one of previously prepared multiple sets each including a set value Tms of the ambient temperature and a time series SF of image data items.

In step ST203, the learning device 101c performs temperature control so that the ambient temperature is maintained at the set value Tms of the ambient temperature of the set selected in step ST202.

In step ST204, the learning device 101c inputs the time series SF of image data items of the set selected in step ST202.

In step ST205, the learning device 101c obtains the measured values Tmf of the temperatures of the light emitting elements.

In step ST206, the learning device 101c obtains the estimated values Tme of the light emitting element temperatures. The estimated values Tme obtained here are estimated values calculated by the element temperature estimator 13c using the set parameter set PS when the ambient temperature is controlled at the set value Tms of the ambient temperature of the selected set and the time series SF of image data items of the selected set is input.

In step ST207, the learning device 101c determines, as errors ER, differences between the measured values Tmf obtained in step ST205 and the estimated values Tme obtained in step ST206.

In step ST208 of FIG. 21, the learning device 101c determines whether the process of steps ST202 to ST207 has been completed for all the multiple sets each including a set value Tms of the ambient temperature and a time series SF of image data items.

When the above process has not been completed for all the multiple sets, it returns to step ST202.

When the above process has been completed for all the multiple sets, it proceeds to step ST209.

In step ST209, the learning device 101c determines a sum ES of the above errors ER (a sum for the multiple sets) as a cost function.

As the sum ES of the errors ER, it is possible to use a sum of absolute values of the errors ER or a sum of squares of the errors ER.

Then, in step ST410, the learning device 101c determines whether the cost function is not more than a predetermined value.

When the cost function is more than the threshold in step ST410, it proceeds to step ST411.

In step ST411, the learning device 101c changes the parameter set PS.

The change is performed so that the cost function is reduced.

In the change, a gradient descent method can be used.

After the change, it returns to step ST202.

When the cost function is not more than the threshold in step ST410, it proceeds to step ST412.

In step ST412, the learning device 101c employs, as an optimum parameter set, the set parameter set PS, i.e., the parameter set PS that was used in the last calculation of the estimated values in step ST206.

In step ST413, synaptic connections whose weights are zero in the employed parameter set PS are broken.

This is the end of the process of generating the neural network.

Thus, the element temperature estimator 13c is formed by the neural network generated by the above process.

The break of the connections in step ST413 simplifies the configuration of the neural network, simplifying the calculation for temperature estimation in image display.

As above, the image processing device according to the third embodiment does not require an image display device including the image processing device to include a temperature sensor for each light emitting element, and can estimate the temperatures of the respective light emitting elements, and prevent the occurrence of unevenness in luminance and chromaticity due to temperature variation, as with the first and second embodiments. In addition, it is possible to correct variation between the light emitting elements, as with the second embodiment.

Although embodiments of the present invention have been described, the present invention is not limited to these embodiments, and various modifications can be made.

For example, in the above examples, each light emitting element is constituted by three LEDs of red, green, and blue. However, the number of LEDs constituting each light emitting element is not limited to three. It is sufficient that each light emitting element be constituted by multiple LEDs.

Also, the image processing devices have been described to perform compensation for both luminance and chromaticity. However, it is sufficient that the image processing devices perform compensation for at least one of luminance and chromaticity.

Also, in the procedure described with reference to FIGS. 11 and 13 regarding the first embodiment and the procedure described with reference to FIG. 20 regarding the third embodiment, a set of a set value Tms of the ambient temperature and a time series SF of image data items is selected in step ST202, and the process of steps ST203 to ST207 is performed for the selected set. Specifically, after input of one time series of image data items is completed, input of the subsequent time series of image data items is started.

However, the process for time series of image data items is not limited to the above method. For example, multiple time series of image data items may partially overlap each other. For example, it is possible to supply image data items of a larger number of frames than the above-described M+1 frames, and repeat a process of using image data items of M+1 frames starting from a certain frame as one time series and using image data items of M+1 frames starting from the frame subsequent to the above certain frame as another time series. In this case, the process of steps ST202 to ST207 is performed in parallel for multiple different time series.

In the first to third embodiments, in learning for optimization of the weights and conversion table or generation of the neural network, the ambient temperature of the image display 2 is controlled. There is a case in which the image display 2 is large in size and it is difficult to place the entire image display 2 in a space in which the air can be conditioned. In this case, when the image display is formed by connecting multiple separate units, it is possible to perform the learning for each separate unit.

Although image processing devices of the present invention have been described above, the image processing methods implemented by the above image processing devices also form part of the present invention. Also, programs for causing computers to execute processes of the above image processing devices or image processing methods, and computer-readable recording media, e.g., non-transitory recording media, storing the programs also form part of the present invention.

### REFERENCE SIGNS LIST

1 image processing device, 2 image display, 3 ambient temperature measurement unit, 9 computer, 11 image input unit, 12 input image storage, 13, 13c element temperature estimator, 14 compensation table storage, 15 temperature variation compensator, 16 image output unit, 31 weight storage, 32 average calculator, 33 conversion table storage, 34 temperature calculator, 17 variation correction coefficient storage, 18 variation corrector, 91 processor, 92 memory, 101, 10c learning device, 102 element temperature measurement unit, 103 temperature control device.

1. An image processing device to correct unevenness in at least one of luminance and color of an image display in which a plurality of light emitting elements each including a plurality of LEDs are arranged, the image processing device comprising:
an element temperature estimator circuit to estimate temperatures of the respective light emitting elements from image data items of input images of a plurality of last frames including a current frame and an ambient temperature of the image display; and
a temperature variation compensator circuit to correct the image data item of the input image of the current frame on a basis of the temperatures of the respective light emitting elements, thereby correcting unevenness in at least one of luminance and chromaticity of the light emitting elements,
wherein the element temperature estimator circuit estimates the temperatures of the light emitting elements on a basis of a relationship between the image data items of the input images of the plurality of frames and measured values of the temperatures of the light emitting elements.

2. The image processing device of claim 1, wherein the element temperature estimator circuit
includes a weight storage to store weights for the image data items of the input images of the plurality of last frames, and
calculates weighted averages of the image data items of the input images of the plurality of last frames by using the weights and calculates the temperatures of the respective light emitting elements on a basis of the weighted averages and the ambient temperature.

3. The image processing device of claim 2, wherein of the weights stored in the weight storage, a weight for the image data item of an input image closer to a current time has a larger value.

4. The image processing device of claim 2, wherein a set of the weights stored in the weight storage is determined by learning using a plurality of learning input data sets each constituted by a set value of the ambient temperature and a time series of image data items.

5. The image processing device of claim 4, wherein
the element temperature estimator circuit further includes a conversion table storage to store a conversion table that associates the weighted averages with temperature rises of the light emitting elements,
the element temperature estimator circuit determines the temperature rises of the light emitting elements corresponding to the weighted averages by referring to the conversion table, and calculates the temperatures of the light emitting elements on a basis of the temperature rises and the ambient temperature, and
the conversion table is determined by learning using the plurality of learning input data sets.

6. The image processing device of claim 5, wherein the weights and the conversion table are obtained by sequentially selecting the plurality of learning input data sets, determining differences between measured values and estimated values of the temperatures of the light emitting elements when the ambient temperature is maintained at the set value of the ambient temperature of the selected learning input data set and the time series of image data items of the selected learning input data set is input, and learning so that a sum of the differences for the plurality of learning input data sets is minimized.

7. The image processing device of claim 5, wherein
the conversion table is obtained by determining, for each of a plurality of grayscale values, as a temperature rise, a difference between a measured value of a temperature of the light emitting elements and the ambient temperature when a time series of image data items in which pixel values are fixed at the grayscale value is input, and
the weights are obtained by sequentially selecting the plurality of learning input data sets, determining differences between measured values and estimated values of the temperatures of the light emitting elements when the ambient temperature is maintained at the set value of the ambient temperature of the selected learning input data set and the time series of image data items of the selected learning input data set is input, and learning so that a sum of the differences for the plurality of learning input data sets is minimized.

8. The image processing device of claim 2, wherein in estimating the temperature of each light emitting element, the element temperature estimator circuit uses, in addition to the weighted average of the image data items for the light emitting element, the weighted average of the image data items for each of one or more of the light emitting elements located around the light emitting element.

9. The image processing device of claim 1, wherein
the element temperature estimator circuit is formed by a neural network, and
the neural network is generated by learning using a plurality of learning input data sets each constituted by a set value of the ambient temperature and a time series of image data items.

10. The image processing device of claim 1, further comprising a variation corrector circuit to correct variation in at least one of luminance and chromaticity between the light emitting elements.

11. The image processing device of claim 10, further comprising a variation correction coefficient storage to store at least one element variation correction coefficient for each light emitting element,
wherein the variation corrector circuit corrects the image data item corrected by the temperature variation compensator circuit by using the correction coefficients stored in the variation correction coefficient storage.

12. An image display device comprising:
the image processing device of claim 1, and
the image display to display an image on a basis of an image data item processed by the image processing device.

13. An image processing method to correct unevenness in at least one of luminance and color of an image display in which a plurality of light emitting elements each including a plurality of LEDs are arranged, the image processing method comprising:
estimating temperatures of the respective light emitting elements from image data items of input images of a plurality of last frames including a current frame and an ambient temperature of the image display; and
correcting the image data item of the input image of the current frame on a basis of the temperatures of the respective light emitting elements, thereby correcting unevenness in at least one of luminance and chromaticity of the light emitting elements,
wherein in the estimation of the element temperatures, the temperatures of the light emitting elements are estimated on a basis of a relationship between the image data items of the input images of the plurality of frames and measured values of the temperatures of the light emitting elements.

14. (canceled)

15. A non-transitory computer-readable recording medium storing a program for causing a computer to execute a process of the image processing method of claim 13.

16. The image processing device of claim 1, wherein the estimation of the temperatures by the element temperature estimator circuit is performed on a basis of a result of execution by a learning device that executes machine learning using a data set including, as input data, the image data items of the input images of the plurality of frames and including, as output data, estimated values obtained by estimating the measured values of the temperatures of the light emitting elements.

17. The image processing method of claim 13, wherein the estimation of the temperatures of the light emitting elements is performed on a basis of a result of execution by a learning device that executes machine learning using a data set including, as input data, the image data items of the input images of the plurality of frames and including, as output data, estimated values obtained by estimating the measured values of the temperatures of the light emitting elements.
